(19) United States
(12) Patent Application Publication
(10) Pub. No.: US 2026/0001323 A1
(43) Pub. Date: Jan. 1, 2026

(54) PRINTING APPARATUS, PRINTING METHOD AND NON-TRANSITORY AND COMPUTER-READABLE MEDIUM STORING PRINTING PROGRAM

(71) Applicant: BROTHER KOGYO KABUSHIKI KAISHA, Nagoya (JP)

(72) Inventors: Shuhei SUZUKI, Obu (JP); Kazunari MATSUURA, Komaki (JP); Hiroya OKUWA, Tajimi (JP); Taiki TANAKA, Yokkaichi (JP); Tatsuya MIYASAKA, Nagoya (JP)

(73) Assignee: BROTHER KOGYO KABUSHIKI KAISHA, Nagoya (JP)

(21) Appl. No.: 19/252,060

(22) Filed: Jun. 27, 2025

(30) Foreign Application Priority Data
Jun. 27, 2024 (JP) 2024-104025

(51) Int. Cl. B41J 2/045; B41J 11/00

(52) U.S. Cl. CPC B41J 2/04593; B41J 2/04573; B41J 2/04586; B41J 11/00214

(57) ABSTRACT

A printing apparatus includes: a head system including a first nozzle and a second nozzle; a light source configured to irradiate an ultraviolet ray; and a controller. The controller is configured to execute: causing the head system to eject the first liquid droplet from the first nozzle based on the image data; causing the head system to eject the second liquid droplet from the second nozzle onto the first liquid droplet that has landed on the print medium; and causing the light source to irradiate the first liquid droplet and the second liquid droplet on the print medium with the ultraviolet ray, and a total area of the second liquid droplet landed on the first liquid droplet is smaller than a total area of an image formed of the first liquid droplet landed on the print medium.

### REFERENCE TO RELATED APPLICATIONS

This application claims priority from Japanese Patent Application No. 2024-104025 filed on Jun. 27, 2024. The entire content of the priority application is incorporated herein by reference.

### BACKGROUND ART

In recent years, in a known printing technique, a droplet of ultraviolet curable ink (UV-curable ink) is ejected onto a print medium. By irradiating the ink droplet which has landed on the print medium with an ultraviolet ray, the ink droplet is cured and fixed to the print medium. By using the droplet of UV-curable ink in such a manner, printing can be performed on print media other than sheets, such as resin or metal, and a print medium with a glossy print surface can be obtained.

### SUMMARY

In the above-described known printing technique, the adhesive force of the ink droplet sometimes causes the print surface of the print medium to become sticky in a case where the print surface is touched (occurrence of the tackiness). This stickiness makes the print surface uncomfortable to touch, and further causes problems such as deterioration in the quality, for example, that the print medium adhering to a packaging film during shipping, or, that in a case where a roll film is wrapped around the print medium, the print medium adhering to the roll film.

In view of the above-described problems, the present disclosure aims to provide a printing apparatus, a printing method and a non-transitory and computer-readable medium storing a printing program each of which has the potential to contribute to a reduction in the stickiness of the print surface of the print medium.

A printing apparatus according to an aspect of the present disclosure includes: a head system including: a first nozzle configured to eject a first liquid droplet onto a print medium based on image data, the first liquid droplet being ultraviolet ray-curable; and a second nozzle configured to eject a second liquid droplet, the second liquid droplet being ultraviolet ray-curable, being different from the first liquid droplet and having an amount smaller than an amount of the first liquid droplet; a light source configured to irradiate an ultraviolet ray for curing the first liquid droplet and the second liquid droplet; and a controller. The controller is configured to execute: causing the head system to eject the first liquid droplet from the first nozzle based on the image data; after causing the head system to eject the first liquid droplet from the first nozzle based on the image data, causing the head system to eject the second liquid droplet from the second nozzle onto the first liquid droplet landed on the print medium; and causing the light source to irradiate the first liquid droplet and the second liquid droplet on the print medium with the ultraviolet ray. A total area of the second liquid droplet landed on the first liquid droplet is smaller than a total area of an image composed of the first liquid droplet landed on the print medium.

According to the present disclosure, the second liquid droplet having the amount smaller than the amount of the first liquid droplet is ejected from the second nozzle onto the first liquid droplet which has landed on the print medium. The total area of the second liquid droplet landed on the first liquid droplet is smaller than the total area of the image formed of the first liquid droplet landed on the print medium. With this, the ejected second liquid droplet may be easily cured by the ultraviolet ray before the second liquid droplet wets and spreads on the first liquid droplet. Accordingly, a contact area in the print surface, of the print medium, in a case where a person touches the contact area can be made small. Thus, the stickiness of the print surface of the print medium may be reduced.

### BRIEF DESCRIPTION OF DRAWINGS

FIG. 1 is a plan view depicting the configuration of a printing apparatus.

FIG. 2 depicts nozzles in each of heads in FIG. 1.

FIG. 3 is a block diagram depicting the configuration of a control system of the printing apparatus of FIG. 1.

FIG. 4 depicts a concept that an ink droplet which has landed on a print medium spreads with the lapse of time immediately after landing on the print medium.

FIG. 5A is a diagram depicting a concept of ink droplets of a color ink ejected from a third head onto the print medium, and FIG. 5B is a diagram depicting a concept of ink droplets of a clear ink ejected from a second head onto the ink droplets of color ink on the print medium.

FIG. 6A is a diagram depicting a partial image of partial image data in block areas, and FIG. 6B is a diagram depicting an area formed of ink droplets of the clear ink ejected onto the partial image of FIG. 6A.

FIG. 7 is a diagram for describing a printing pass in which the ink droplets of clear ink is to be ejected during a tackiness reducing process.

FIG. 8 is a diagram for describing that an area formed in a first printing pass during the tackiness reducing process does not overlap with an area formed in a second printing pass following the first printing pass.

FIG. 9A is a diagram depicting a driving waveform of an ordinary small droplet according to the clear ink, and FIG. 9B is a diagram depicting a driving waveform of an extra-small droplet according to the clear ink.

FIG. 10 is a flowchart indicating the flow of a process in an image processing device.

FIG. 11 is a flowchart indicating the flow of a process in an output device.

### DESCRIPTION

In the following, a printing apparatus according to an embodiment of the present disclosure will be described with reference to the drawings. The printing apparatus described below is merely an embodiment of the present disclosure. Therefore, the present disclosure is not limited to the following embodiment, and additions, deletions, and changes are possible within the spirit of the present disclosure. In the following, the same or corresponding elements are denoted by the same reference symbols throughout all the drawings, and overlapping descriptions will be omitted unless otherwise noted.

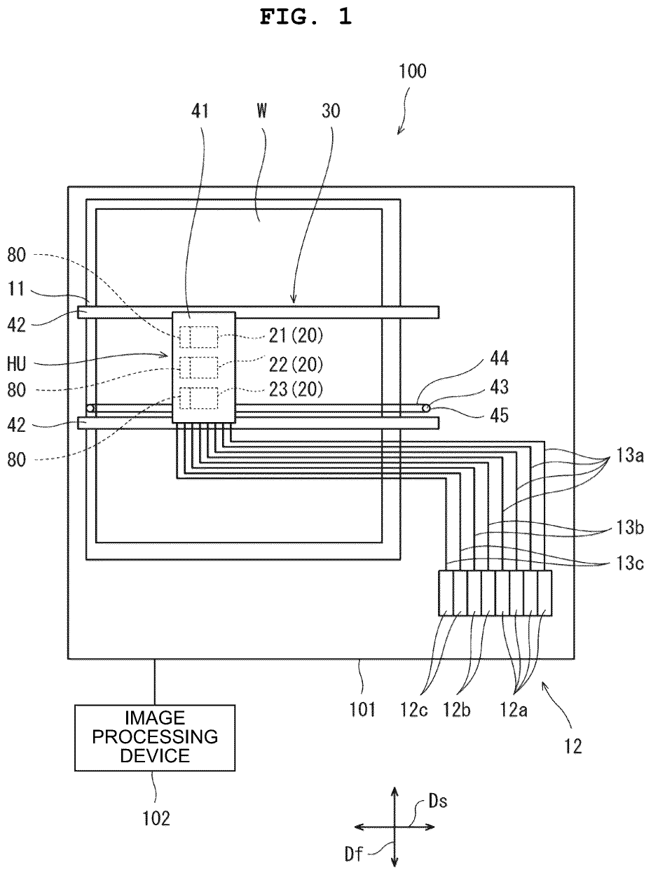

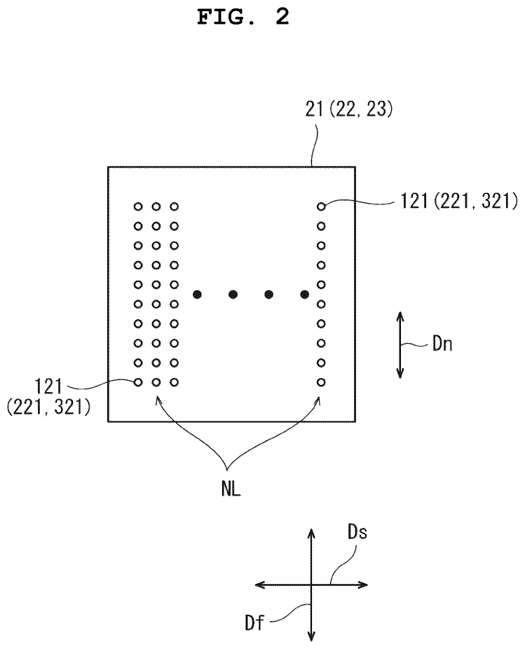

In FIG. 1 and FIG. 2, directions orthogonal to each other are defined as a first direction Df and a second direction Ds. In the present embodiment, for example, the first direction Df is a conveying direction in which a print medium Wis conveyed, and the second direction Ds is a moving direction in which a carriage 41 described later is moved. In the following description, “Ds” is referred to as the moving direction Ds, and “Df” is referred to as the conveying direction Df. However, the above-described directions are merely examples and the present disclosure is not limited to these directions.

The printing apparatus 100 includes an output device 101 and an image processing device 102. The output device 101 and the image processing device 102 are connected to be able to communicate with each other via a wire or wirelessly, such as a network. The image processing device 102 generates print data from image data of a print image which is an image to be printed on a print medium W by the output device 101, and transmits the generated print data to the output device 101 via the wire or wirelessly. The output device 101 prints the print image on the print medium W based on the print data received from the image processing device 102. Note that examples of the print medium W include fabric, resin material, metal material, and film which is cut.

The output device 101 is, for example, an ink-jet printer based on the serial head system. The output device 101 alternately repeats a pass process of ejecting an ink droplet while moving an ink-jet head 20 (hereinafter referred to as “head 20”) in the moving direction Ds based on the print data, and a conveying process of conveying the print medium W in the conveying direction Df. With this, a predetermined image is printed on the print medium W. Note that in FIG. 1, the print medium W is conveyed in a direction, regarding the conveying direction Df, from the lower part toward the upper part of the sheet surface of FIG. 1.

The output device 101 includes a head unit HU having a plurality of heads 20, a platen 11, a plurality of tanks 12, a moving device 30, a conveyor 40, and a light source 80.

Each of the plurality of heads 20 prints an image on the print medium W using a predetermined ink droplet based on the print data. Examples of the plurality of heads 20 included in the head unit HU include a first ink-jet head 21 (hereinafter referred to as a “first head 21”), a second ink-jet head 22 (hereinafter referred to as a “second head 22”), and a third ink-jet head 22 (hereinafter referred to as a “third head 23”). The first head 21, the second head 22, and the third head 23 are aligned in this order from one side of the conveying direction Df. With this, the second head 22 is disposed downstream of the third head 23 in the conveying direction Df of the print medium W. Further, the first head 21 is disposed downstream of the second head 22 in the conveying direction Df of the print medium W. Note that in the following description, in a case where the term “head 20” is used, the head 20 is intended to include the first head 21, the second head 22, and the third head 23.

In the present embodiment, for example, the first head 21 performs printing on the print medium W using UV-curable white ink, the second head 22 performs printing on the print medium W using UV-curable clear ink, and the third head 23 performs printing on the print medium W using UV-curable color ink. In the present embodiment, the third head 23 corresponds to the first head, and the second head 22 corresponds to the second head. However, the above-described colors of the inks ejected, respectively, by the heads 20 are merely examples and can be changed as appropriate. Note that a head which ejects ink of a special color may be included.

The platen 11 has a flat upper surface and defines the distance between the print medium W placed on the upper surface and the nozzle surface of each of the heads 20 disposed to face the print medium W. The platen 11 reciprocates in the conveying direction Df. With this, the print medium W supported by the platen 11 reciprocates in the conveying direction Df.

The ink is stored in each of the tanks 12. The tanks 12 are connected to the first to third heads 20 via channels to be described below in order to supply the ink to each of the first to third heads 20. Each of the tanks 12 is a container which stores the ink. The number of the tank 12 is equal to or greater than the number of the type of ink. For example, the tanks 12 include four first tanks 12a storing, respectively, four kinds of color inks, one second tank 12b or a plurality of second tanks 12b storing the white ink, and one third tank 12c or a plurality of third tanks 12c storing the clear ink. Examples of the color ink include a cyan ink, a magenta ink, a yellow ink, and a black ink.

The first tank 12a is connected to the third head 23 by a first channel 13a. The color ink is supplied from the first tank 12a to the third head 23 via the first channel 13a. The second tank 12b is connected to the first head 21 by a second channel 13b. The white ink is supplied from the second tank 12b to the first head 21 via the second channel 13b. The third tank 12c is connected to the second head 22 by a third channel 13c. The clear ink is supplied from the third tank 12c to the second head 22 via the third channel 13c.

The conveyor 40 has a driving part including, for example, a non-illustrated ball screw or rack and pinion, etc., and a conveying motor 46. The driving part is connected to the conveying motor 46. The platen 11 moves in the conveying direction Df by a rotating operation of the conveying motor 46, and conveys the print medium W in the conveying direction Df.

The moving device 30 includes a carriage 41, two guide rails 42, a moving motor 34, and an endless belt 44. The two guide rails 42 extend in the moving direction Ds above the platen 11 so that the carriage 41 is interposed between the two guide rails 42 in the conveying direction Df. The carriage 41 supports the first head 21, the second head 22, and the third head 23. The carriage 41 is supported by the two guide rails 42 so as to be movable in the moving direction Ds. The endless belt 44 extends in the moving direction Ds and is attached to the carriage 41, and is attached to the moving motor 34 via a pulley 45. As the moving motor 34 rotates, the endless belt 44 is operated. As a result, the carriage 41 reciprocates in the moving direction Ds along the guide rails 42 while supporting the first head 21, the second head 22, and the third head 23. As a result, the first head 21, the second head 22, and the third head 23 are reciprocated in the moving direction Ds by the carriage 41.

The light source 80 is included in each of the heads 20. The light source 80 is disposed adjacent to (a side surface of) each of the heads 20 in the moving direction Ds. The light source 80 corresponding to the first head 21 irradiates an ultraviolet ray which cures the ink droplet of white ink ejected from the first head 21. The light source 80 corresponding to the second head 22 irradiates the ultraviolet ray which cures the ink droplet of clear ink ejected from the second head 22. The light source 80 corresponding to the third head 23 irradiates the ultraviolet ray which cures the ink droplet of the color ink ejected from the third head 23.

Next, as depicted in FIG. 2, the first head 21, the second head 22, and the third head 23 have the same configuration. The first head 21 has a plurality of nozzles 121. The first head 21 has a plurality of nozzle arrays NL constructed of the plurality of nozzles 121 aligned in a predetermined nozzle array-direction Dn at a predetermined distance. Each of the plurality of nozzle arrays NL extends in the nozzle array-direction Dn. The nozzle array-direction Dn is, for example, a direction parallel to the conveying direction Df. These nozzle arrays NL are disposed side by side at a predetermined distance in the moving direction Ds. The disposition of the nozzle arrays NL in the second head 22 and the disposition of the nozzle arrays NL in the third head 23 are similar to the disposition of the nozzle arrays NL in the first head 21. Further, in FIG. 2, each of the nozzles constructing the nozzle arrays NL in the second head 22 is referred to as a “nozzle 221”, and each of the nozzles constructing the nozzle arrays NL in the third head 23 is referred to as a “nozzle 321”. The second head 22 has a plurality of nozzles 221. The third head 23 has a plurality of nozzles 321.

The nozzle 321 is configured to eject, to the print medium W, based on the image data, an ink droplet of the color ink as a first liquid droplet which is ultraviolet ray-curable so as to form an image. Further, the nozzle 221 is configured to eject an ink droplet of the clear ink, as a second liquid droplet which is ultraviolet ray-curable and different from the ink droplet of the color ink, and which has a smaller amount than the amount of the ink droplet of the color ink. Thus, the printing apparatus 100 use the small droplet as the liquid droplet to be ejected from the nozzle 221 rather than the large droplet to be ejected from the nozzle 321. Furthermore, the nozzle 121 is configured to eject, to the print medium W, based on the image data, an ink droplet of the ultraviolet ray-curable white ink to the print medium W so as to form an image, etc. In the present embodiment, each of the nozzles 121, 221, and 321 is capable of ejecting a large droplet, a medium droplet, and a small droplet as the ink droplet. In the present embodiment, each of the nozzles 121, 221, and 321 eject a large droplet as the ink droplet, except for a second printing process which will be described later. Note that the nozzle 321 corresponds to a first nozzle, and the nozzle 221 corresponds to a second nozzle.

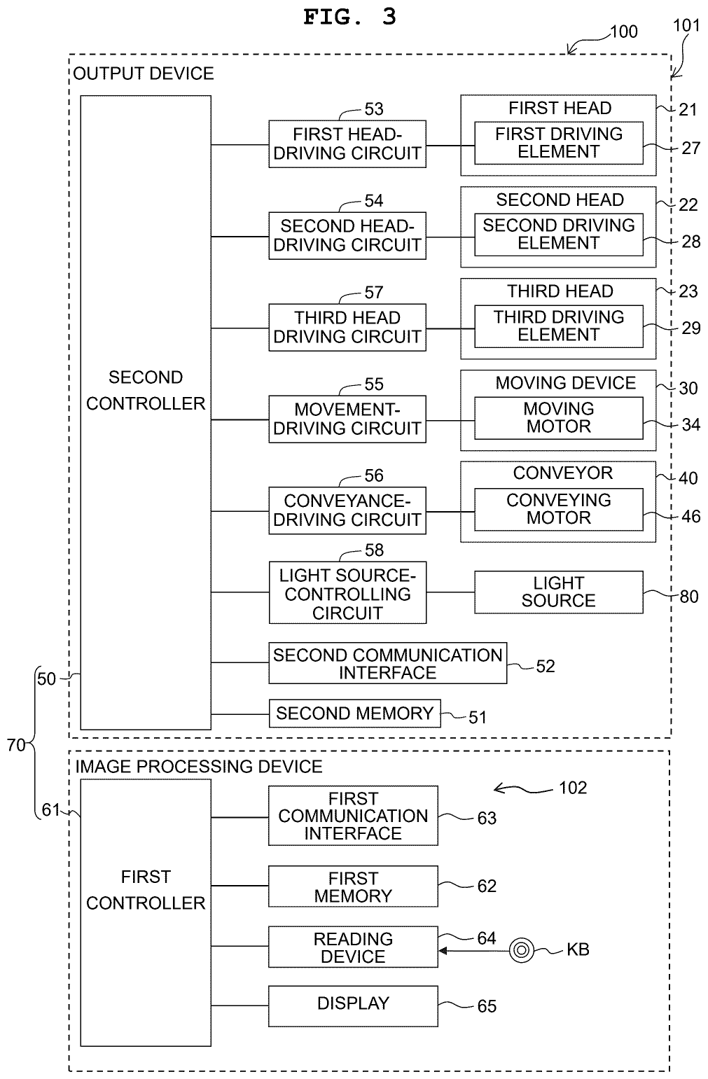

As depicted in FIG. 3, the first head 21 includes a first driving element 27 disposed with respect to each of the nozzles 121. The second head 22 includes a second driving element 28 disposed with respect to each of the nozzles 221. The third head 23 includes a third driving element 29 disposed with respect to each of the nozzles 321. Each of the first driving element 27, the second driving element 28 and the third driving element 29 is, for example, a piezoelectric element, a heating element, or an electrostatic actuator. Each of the first, second and third driving elements 27, 28 and 29 applies, to the ink, pressure causing the ink to be ejected as an ink droplet from a corresponding one of the nozzles 121, 221 and 321.

The output device 101 in the printing apparatus 100 includes a second controller 50. Further, the output device 101 includes a second memory 51, a second communication interface 52, a first head-driving circuit 53, a second head-driving circuit 54, a third head-driving circuit 57, a movement-driving circuit 55, a conveyance-driving circuit 56, and a light source-controlling circuit 58 which are connected to the second controller 50.

The second memory 51 is a memory accessible from the second controller 50 and includes, for example, a RAM and a ROM. The RAM temporarily stores the print data and various kinds of data to be used in a case where the second controller 50 performs calculation. The ROM stores a printing program and various kinds of data with which the second controller 50 carries out the various kinds of data process.

The second controller 50 is constructed of a computer, and includes, for example, a processor such as a CPU. The second controller 50 controls the operations of the parts of the output device 101 by executing the printing program while referring to the data stored in the second memory 51. Note that the second controller 50 may be constructed of a single device or may be configured such that a plurality of independently disposed devices cooperate to perform the operation of the output device 101. Further, the second controller 50 receives the various kinds of data, such as the print data, etc., from the image processing device 102 via the second communication interface 52. The term “processor/controller” encompasses both a single processor/controller or a group of multiple processors/controllers located either locally or remotely working together or in a distributed fashion to collectively perform the tasks attributed to the “processor/controller” described herein.

The first head-driving circuit 53 includes a multiplexer, and controls the operation of the first driving element 27 based on an instruction from the second controller 50. In this case, the second controller 50 outputs, to the first head-driving circuit 53, a control signal by which the first driving element 27 is driven, and the first head-driving circuit 53 generates a driving signal based on the control signal and outputs this driving signal to the first driving element 27. Based on the driving signal, the first driving element 27 applies predetermined ejecting energy to the white ink in the first head 21 at a predetermined timing. This causes the first head 21 to eject the white ink from the nozzle 121. The second head-driving circuit 54, similarly to the first head-driving circuit 53, includes a multiplexer, and controls the operation of the second driving element 28 based on an instruction from the second controller 50. This causes the second head 22 to be ejected from the nozzle 221. The third head-driving circuit 57, similarly to the first head-driving circuit 53 and the second head-driving circuit 54, includes a multiplexer and controls the operation of the third driving element 29 based on an instruction from the second controller 50. This causes the third head 23 to eject the color ink from the nozzle 321.

The movement-driving circuit 55 controls the operation of the moving motor 34 of the moving device 30 based on an instruction from the second controller 50. This causes the carriage 31 to reciprocate in the moving direction Ds. Therefore, the first head 21, the second head 22, and the third head 23 reciprocate in the moving direction Ds.

The conveyance-driving circuit 56 controls the operation of the conveying motor 46 of the conveyor 40 based on an instruction from the second controller 50. With this, the platen 11 conveys the print medium W intermittently or continuously along the conveying direction Df and stops the print medium W at a predetermined position.

The light source-controlling circuit 58 causes the light source 80 to irradiate the ultraviolet ray based on an instruction from the second controller 50. With this, the ink droplets ejected onto the print medium W are cured by the ultraviolet ray.

The image processing device 102 in the printing apparatus 100 is a device which processes the print image to be printed by the output device 101 and is constructed, for example, of a personal computer, a tablet, or a smartphone. The image processing device 102 includes a first controller 61, as well as a first memory 62, a first communication interface 63, a reading device 64, and a display 65 which are connected to the first controller 61.

The first memory 62 is a memory accessible from the first controller 61, and includes, for example, a RAM and a ROM. The RAM temporarily stores the image data and various kinds of data to be used in a case where the first controller 61 performs the calculation. The ROM stores the printing program and the various kinds of data which are used by the second controller 61 to carry out the various kinds of data process. Examples of the image data include, for example, raster data which indicates an image to be printed on the print medium W.

The first controller 61 is constructed of a computer and includes, for example, a processor such as a CPU. The first controller 61 controls the operation of the output device 101 and the operation of the display device 65 by executing the printing program while referring to the data stored in the first memory 62. Note that the first controller 61 may be constructed of a single device or may be configured such that a plurality of independently disposed devices cooperate with each other to perform the operation of the image processing device 102. The first controller 61 transmits the various kinds of data, such as the print data to the output device 101 via the first communication interface 63. In the present embodiment, the first controller 61 cooperates with the second controller 50 of the output device 101 to construct the controller 70 of the printing apparatus 100. As described above, the term “processor/controller” encompasses both a single processor/controller or a group of multiple processors/controllers located either locally or remotely working together or in a distributed fashion to collectively perform the tasks attributed to the “processor/controller” described herein. The controller 70 is an example of “a controller” of the present disclosure.

The reading device 64 reads the printing program stored in a storage medium KB which is, for example, a CD-ROM or a USB flash memory. The read printing program is stored in the first memory 62. Alternatively, the printing program may be downloaded via a predetermined communication network and stored in the first memory 62. The display device 65 is, for example, a touch panel display, and outputs operation information from a user to the first controller 61. Further, the display device 65 displays, based on the image data, the print image, etc., which is to be printed by the output device 101.

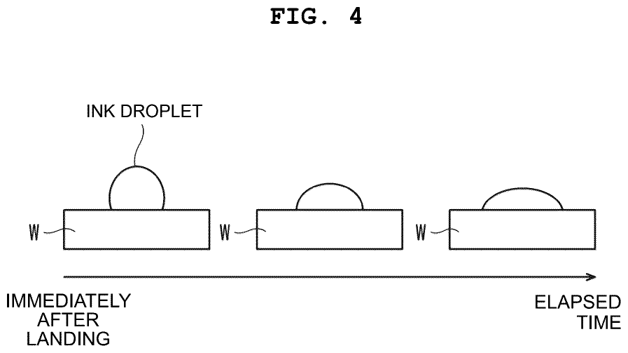

Next, FIG. 4 depicts a concept that an ink droplet, which has landed on the print medium W, spreads with the lapse of time immediately after landing on the print medium W.

As depicted in FIG. 4, the ink droplet ejected from each of the heads 20 and landed on the print medium W tends to wet and spread on the print medium W with the lapse of time immediately after the landing. Therefore, in a case where the ink droplet is cured by the ultraviolet ray in a wet and spread state on the print medium W, the surface area of the ink droplet (aggregate of ink droplets) after curing, in other words, the contact area which a person can touch, becomes large. Therefore, due to the adhesive force of the droplet of the UV-curable ink, in a case where a person touches the print surface of the print medium W, stickiness might occur (tackiness might occur). Therefore, in the printing apparatus 100 of the present embodiment, a process for reducing tackiness (hereinafter referred to as a “tackiness reducing process”) is executed.

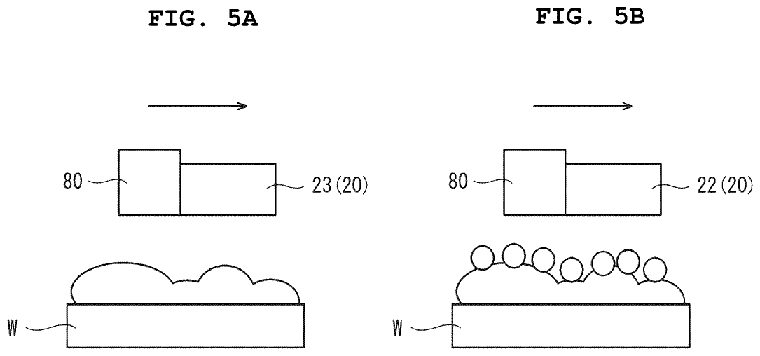

FIG. 5A is a diagram depicting a concept of an ink droplet of the color ink ejected from the third head 23 onto the print medium, and FIG. 5B is a diagram depicting a concept of an ink droplet of the clear ink ejected from the second head 22 onto the ink droplet of the color ink on the print medium.

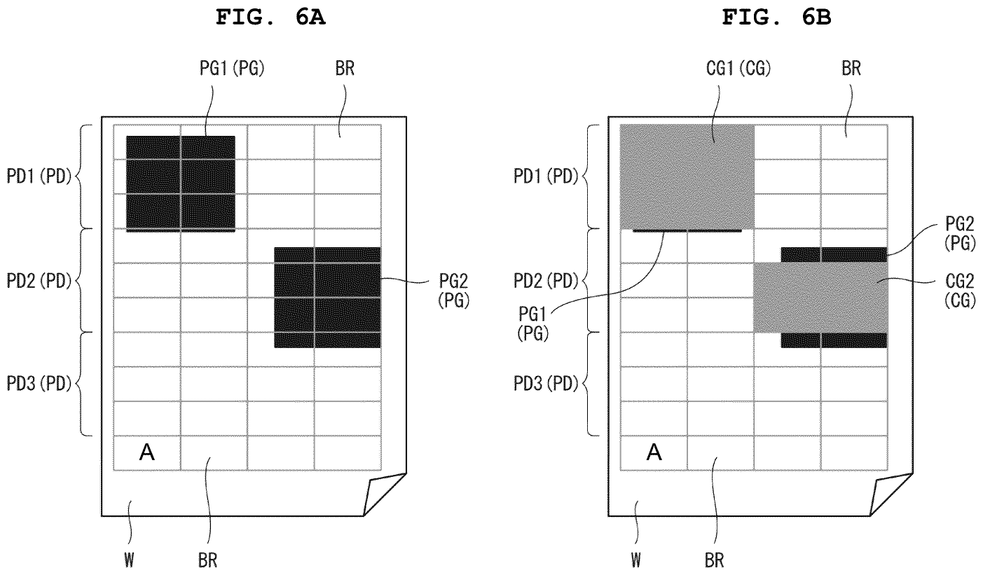

The first controller 61 executes a process of generating first print data for causing the third head 23 to eject an ink droplet of the color ink from the nozzles 321 onto the print medium W, based on the image data. Further, the first controller 61 executes a process of generating second print data for causing the head 22 to eject an ink droplet of the clear ink from the nozzle 221 onto the ink droplet of the color ink which has landed on the print medium, based on the image data. This second print data is generated with respect to a block area BR (FIG. 6) in which the print rate is a predetermined value or more. The details of the second print data and the block area BR will be described later. The first controller 61 transmits the first print data and the second print data to the second controller 50 via the first communication interface 63.

The second controller 50 executes a first printing process of causing the third head 23 to eject an ink droplet of the color ink from the nozzles 321 based on the first print data, which is based on the image data, as depicted in FIG. 5A. In other words, the second controller 50 causes the third head 23 to execute the first printing process. With this, a predetermined image is formed on the print medium W of the ink droplets of the color ink.

The second controller 50 executes a curing process of causing the light source 80 to irradiate the ink droplets of the color ink, which has landed on the print medium with the ultraviolet ray. In this case, according to an aspect in which the light source 80 is disposed upstream of the third head 23 in the moving direction Ds during the execution of a printing pass, the light source 80 irradiates the ink droplets of the color ink with the ultraviolet ray immediately after the ink droplets have been ejected from the third head 23. With this, the ink droplet of the color ink may be cured immediately after the ink droplets have been ejected.

Next, as depicted in FIG. 5B, after the first printing process and the curing process, the second controller 50 executes a second printing process of causing each of the second head 22 to eject a droplet of the clear ink, of which amount is smaller than the amount of the droplet of the color ink, onto the droplet of the color ink which has landed on the print medium W. That is, the second controller 50 causes the second head 22 to execute the second printing process. With this, the droplets of the clear ink are ejected onto the droplets of the color ink which have been cured in the wet and spread state on the print medium W. In this case, among the large droplet, medium droplet, and small droplet which can be ejected from the nozzle 221, the second controller 50 uses the small droplet as the droplet of clear ink in the second printing process. With this, the ink droplet of the clear ink, which is a small droplet, is ejected onto the ink droplet of the color ink, which is a large droplet and which has landed on the print medium W, and therefore the ejection amount of the ink droplet of the clear ink is smaller than the ejection amount of the ink droplet of the color ink.

In this case, the total area of the ink droplets of the clear ink which have landed on the ink droplets of the color ink is smaller than the total area of the image composed of the ink droplets of the color ink which have landed on the print medium W. Specifically, for example, the area per one pass of the ink droplets of the clear ink each of which has landed on a corresponding one of the ink droplets of the color ink is smaller than the area per one pass of the image composed of the ink droplets of the color ink which have landed on the print medium W. More specifically, for example, the area per unit area (e.g., per pixel) per one pass of the ink droplets of the clear ink each of which has landed on the corresponding one of the ink droplets of the color ink is smaller than the area per unit area per one pass (e.g., per pixel) of the image composed of the ink droplets of the color ink which have landed on the print medium W.

The second controller 50 executes the curing process of causing the light source 80 to irradiate, with the ultraviolet ray, the ink droplets of the clear ink each of which has landed on the corresponding one of the ink droplets of the color ink on the print medium. In this case, according to the aspect in which the light source 80 is disposed upstream of the second head 22 in the moving direction Ds during the execution of the printing pass, the light source 80 irradiates the ink droplets of the clear ink with the ultraviolet ray immediately after the ink droplets have been ejected from the second head 22. With this, the ink droplets of the clear ink may be cured immediately after the ink droplets have been ejected. The above-described first printing process, second printing process, and curing process are performed with respect to each of multiple partial image data PD (FIG. 6) to be described later.

In a case where the second controller 50 causes the third head 23 to eject the ink droplet of the color ink from the nozzles 321 in the first printing process, the second controller 50 may move the carriage 41 in the moving direction Ds at a first speed. With this, the nozzle 321 ejects the ink droplet of the color ink to the print medium W while moving in the moving direction Ds at the first speed. Further, in a case where the second controller 50 causes the second head 22 to eject the ink droplet of the clear ink from the nozzle 221 in the second printing process, the second controller 50 may move the carriage 41 in the moving direction Ds at a second speed faster than the first speed. With this, the nozzle 221 ejects the ink droplet of the clear ink to the print medium W while moving in the moving direction Ds at the second speed. Note that the second printing process is performed in a printing pass different from the printing pass of the first printing process. Alternatively, the second head 22 and the third head 23 may be configured to be supported, respectively, by mutually different carriages. In this situation, in a case where the second controller 50 causes the third head 23, supported by one of the carriages, to eject the ink droplet of the color ink from the nozzle 321 in the first printing process, the second controller 50 causes the one carriage to move in the moving direction Ds at the first speed. Further, in a case where the second controller 50 causes the second head 23, supported by the other of the carriages, to eject the ink droplet of the clear ink from the nozzle 221 in the second printing process, the second controller 50 causes the other of the carriages to move in the moving direction Ds at the second speed.

In the following, the tackiness reducing process in the present embodiment will be specifically described. FIG. 6A is a diagram depicting a partial image PG of partial image data in block areas BR, and FIG. 6B is a diagram depicting an area CG formed of ink droplets of the clear ink ejected onto the partial image PG in FIG. 6A.

After the first controller 61 of the image processing device 102 obtains the image data, the first controller 61 executes a process of obtaining multiple partial image data PD each of which partially constructs the image data as depicted in FIG. 6A. With this, the image data is divided into the multiple partial image data PD. In FIG. 6A and FIG. 6B, partial image data PD1, partial image data PD2, and partial image data PD3 are illustrated as example of three pieces of the partial image data PD. Note that areas each of which corresponds to one of the partial image data PD PD1 to PD3 may be, for example, an area corresponding to one printing pass of the second head 22 and the third head 23.

Next, the first controller 61 executes a process of dividing each of the areas corresponding to one of the multiple partial image data PD into a plurality of block areas BR. For example, the area corresponding to each of the multiple partial image data PD may be divided into 12 block areas BR constructed of 3 rows and 4 columns. Note that in FIG. 6A and FIG. 6B, 40 block areas BR constructed of 10 rows and 4 columns are illustrated in the entirety of the image data. In the following, in a case where each of the 40 block areas BR is identified, the description will be given using row and column numbers.

Further, the first controller 61 obtains a print rate (duty) in each of the block areas BR divided as described above. For example, with respect to the partial image data PD1 in FIG. 6A, the first controller 61 obtains the print rate with respect to each of the block areas BR based on the data of a part of the partial image data PD1 which corresponds to the block area BR regarding which the print rate is to be obtained. With this, the print rate in each of the block areas BR is obtained with respect to each of the block areas BR. The foregoing process is applied similarly to each of the block areas BR in the partial image data PD2 and each of the block areas BR in the partial image data PD3.

Afterward, the first controller 61 determines whether the printing rate in each of the block areas BR is a predetermined value (e.g., 50%) or more, with respect to each of the block areas BR. For example, regarding the partial image data PD1 in FIG. 6A, the partial image PG1 exists over a block area BR in the first row and the first column, a block area BR in the first row and the second column, a block area BR in the second row and the first column, a block area BR in the second row and the second column, a block area BR in the third row and the first column, and a block area BR in the third row and the second column. The first controller 61 determines that the print rate of each of the block area BR in the first row and the first column, the block area BR in the first row and the second column, the block area BR in the second row and the first column, the block area BR in the second row and the second column, the block area BR in the third row and the first column, and the block area BR in the third row and the second column is the predetermined value or more. Note that the predetermined value of the print rate can be changed as appropriate.

Similarly, regarding the partial image data PD2 in FIG. 6A, the partial image PG2 exists over a block area BR in the fourth row and the third column, a block area BR in the fourth row and the fourth column, a block area BR in the fifth row and the third column, a block area BR in the fifth row and the fourth column, a block area BR in the sixth row and the third column, and a block area BR in the sixth row and the fourth column. On the other hand, regarding the partial image data PD2, a part of the partial image PG1 exists in a block area BR in the fourth row and the first column and in a block area BR in the fourth row and the second column. In this example, the first controller 60 determines that each of the print rate of the block area BR in the fourth row and the first column, the print rate of the block area BR in the fourth row and the second column, the print rate of the block area BR in the fourth row and the third column, and the print rate of the block area BR in the fourth row and the fourth column is less than the predetermined value. Therefore, the first controller 61 determines that each of the print rate of the block area BR in the fifth row and the third column, the print rate of the block area BR in the fifth row and the fourth column, the print rate of the block area BR in the sixth row and the third column, and the print rate of the block area BR in the sixth row and the fourth column is the predetermined value or more.

Similarly, regarding the partial image data PD3 in FIG. 6A, a part of the partial image PG2 exists in a block area BR in the seventh row and the third column and in a block area BR in the seventh row and the fourth column. In this example, the first controller 60 determines that each of the print rate of the block area BR in the seventh row and the third column and the print rate of the block area BR in the seventh row and the fourth column is less than the predetermined value. Therefore, the first controller 61 determines that regarding the partial image data PD3 in FIG. 6A, a block area BR in which print rate is the predetermined value or more is not present.

In a case where the first controller 61 determines that the printing rate is the predetermined value or more in a certain block area BR included in the block areas BR in certain partial image data PD among the multiple partial image data PD, the first controller 61 generates the second print data with respect to the certain partial image data PD including the certain block area BR in which the printing rate is the predetermined value or more. In this case, the first controller 61 may generate the second print data with respect to each of the multiple partial image data PD. For example, regarding the partial image data PD1, the first controller 61 generates the second print data for ejecting the ink droplets of the clear ink with respect to a total of six block areas BR which are the block area BR in the first row and the first column, the block area BR in the first row and the second column, the block area BR in the second row and the first column, the block area BR in the second row and the second column, the block area BR in the third row and the first column, and the block area BR in the third row and the second column and in each of which the printing rate is the predetermined value or more. That is, the first controller 61 generates the second print data with respect to each of the block areas BR in which the printing rate is the predetermined value or more. In the example of FIG. 6B, the second print data for ejecting the ink droplets of the clear ink to an area CG1 including the above-described six block areas BR as an area CG to be formed of the ink droplets of the clear ink. Note, however, that the area CG1 may be at the same position and may have the same area with respect to the partial image PG1 in the block area BR in the first row and the first column, the block area BR in the first row and the second column, the block area BR in the second row and the first column, the block area BR in the second row and the second column, the block area BR in the third row and the first column, and the block area BR in the third row and the second column.

Similarly, regarding the partial image data PD2, the first controller 61 generates the second print data for ejecting the ink droplets of the clear ink to a total of four block areas BR which are the block area BR in the fifth row and the third column, the block area BR in the fifth row and the fourth column, the block area BR in the sixth row and the third column, and the block area BR in the sixth row and the fourth column and in each of which the print rate is the predetermined value or more. In the example of FIG. 6B, the second print data for ejecting the ink droplets of the clear ink to an area CG2 including the above-described four block areas BR, as the area CG to be formed of the ink droplets of the clear ink. Note, however, that the above-described area CG2 may be at the same position and may have the same area as the partial image PG2 in the block area BR in the fifth row and the third column, the block area BR in the fifth row and the fourth column, the block area BR in the sixth row and the third column, and the block area BR in the sixth row and the fourth column.

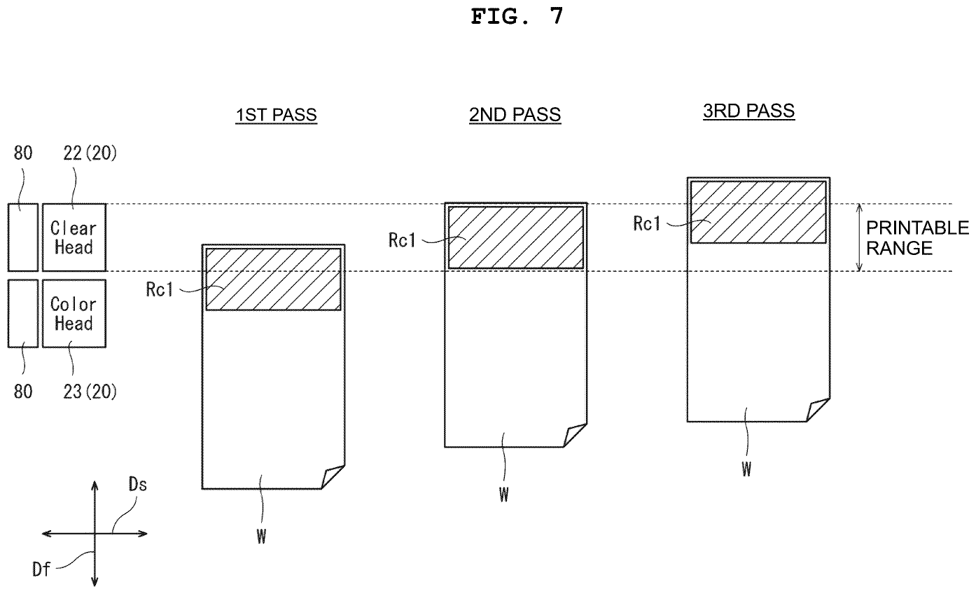

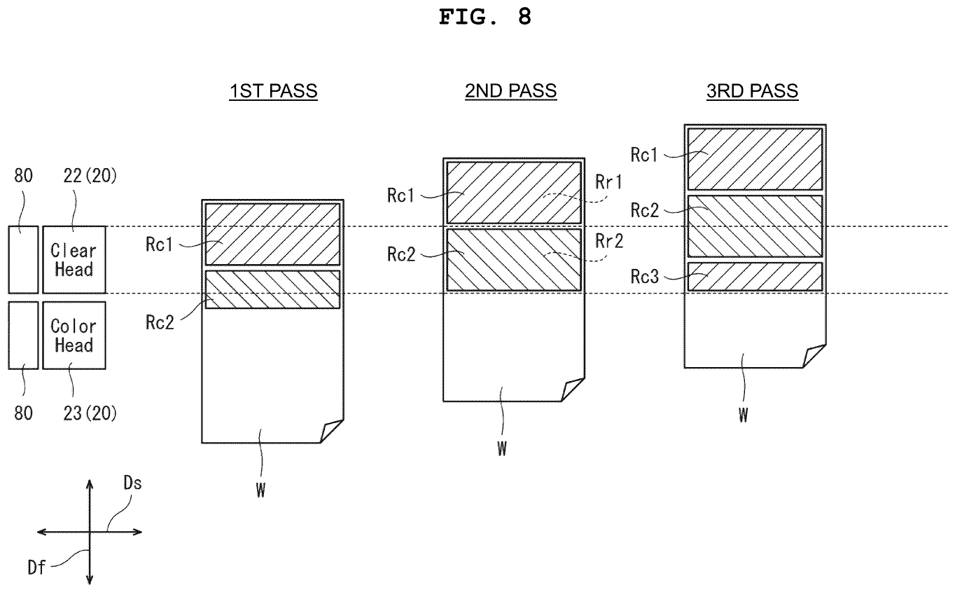

FIG. 7 is a diagram describing a printing pass in which the ink droplets of the clear ink are to be ejected during the tackiness reducing process, and FIG. 8 is a diagram describing that an area Rc1 formed in the first printing pass during the tackiness reducing process does not overlap with an area Rc2 formed in the second printing pass subsequent to the first printing pass.

In the above-described second printing process, the second controller 50 causes the second head 22 to eject the ink droplets of the clear ink in a printing pass in which the print range by the second head 22 becomes maximum. In this case, the second controller 50 specifies the printing pass in which the print range becomes maximum, based on the position of the area CG to which the ink droplets of the clear ink are to be ejected and based on the conveyance amount in the conveying direction Df of the print medium W as described with reference to FIG. 6B. In the example of FIG. 7, in the first pass (first printing pass), the range in which the ink droplets of the clear ink can be ejected to the area Rc1 having the ink droplets of the color ink ejected by the third head 23 is only a part of the area Rc1 in the conveying direction Df. Further, in the third pass (third printing pass), although the range in which the ink droplets of the clear ink can be ejected to the area Rc1 having the ink droplets of the color ink ejected by the third head 23 is greater than the range in the first pass, this range is also only a part of the area Rc1 in the conveying direction Df. On the other hand, in the second pass (second printing pass), the range in which the ink droplets of the clear ink can be ejected to the area Rc1 having the ink droplets of the color ink ejected by the third head 23 includes the entirety of the area Rc1. Therefore, in a case where the second head 22 are caused to eject the ink droplets of the clear ink from the nozzles 221 in the printing pass in which the print range by the second head 22 becomes maximum, the ink droplets of the clear ink can be ejected onto the ink droplets of the color ink in the area Rc1 in one printing pass. In this case, the second controller 50 turns the light source 80 on only in a case where the ink droplets of the clear ink are (being) ejected in the above-described printing pass. The second controller 50 turns off the light source 80 in the printing passes other than the printing pass in which the ink droplets of the clear ink are ejected.

Further, as depicted in FIG. 8, the second controller 50 executes the second printing process so that a first area Rr1 and a second area Rr2 do not overlap. The ink droplets of the clear ink are ejected to the first area Rr1 from the nozzle 221 in the first printing pass. The ink droplets of the clear ink are ejected to the second area Rr2 from the nozzle 221 in the second printing pass. In the example of FIG. 8, the second head 22 ejects the ink droplets of the clear ink to the first area Rr1 corresponding to the area Rc1 to which the third head 23 has ejected the ink droplets of the color ink in the first printing pass. Then, the second controller 50 controls the conveyance amount of the print medium W so that the second area Rr2 corresponding to the area Rc2 to which the third head 23 ejects the ink droplets of the color ink in the second printing pass does not overlap with the first area Rr1. With this, the second head 22 ejects the ink droplets of the clear ink to the second area Rr2 which does not overlap with the first area Rr1.

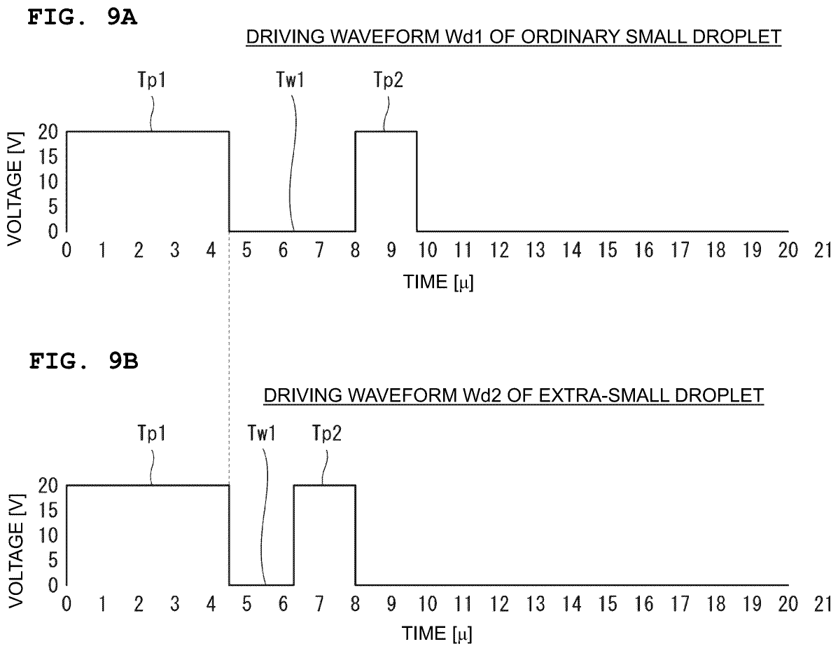

Here, although the case wherein the small droplet is ejected from the nozzle 221 of the second head 22 has been described above, an extra-small droplet may be ejected from the nozzle 221 as follows. FIG. 9A is a diagram depicting a driving waveform Wd1 of an ordinary small droplet according to the clear ink, and FIG. 9B is a diagram depicting a driving waveform Wd2 of an extra-small droplet according to the clear ink.

In the second printing process, the second controller 50 performs switching from the driving waveform Wd1, depicted in FIG. 9A, for causing the second head 22 to eject a small droplet, which can be ejected from the nozzle 221, to the driving waveform Wd2, depicted in FIG. 9B, for dividing the volume of the small droplet into a plurality of extra-small droplets and causing the second head 22 to eject the plurality of extra-small droplets, which can be ejected from the nozzle 221. In the driving waveform Wd1 of FIG. 9A, a pulse TP1 indicating the ejection timing is High, and a pulse Tw1 indicating the non-ejection timing is Low. The width of the pulse Tw1 in FIG. 9B is smaller than the width of the pulse Tw1 in FIG. 9A. In a case where the ejection control of the third head 23 and the second head 22 is executed by the second controller 50 using the driving waveform Wd1, the speed of the tail of the ejected ink droplet increases due to the relatively long width of the pulse Tw1, thereby promoting a combined droplet of the ink droplets and extending the tail of the combined ink droplet. Therefore, the ink droplet ejected from each of the third head 23 and the second head 22 is a small droplet. On the other hand, in a case where the ejection control of the second head 22 is executed by the second controller 50 using the driving waveform Wd2, the speed of the tail of the ejected ink droplet decreases due to the relatively short width of the pulse Tw1, thereby making the generation of the combined droplet of the ink droplets difficult. Therefore, the ink droplet ejected from each of the third head 23 and the second head 22 is an extra-small droplet.

In the present embodiment, the second controller 50 transmits a predetermined driving waveform to each of the third head 23 and the second head 22. The second controller 50 further transmits data represented by each of signals of ink droplet sizes “11” (large droplet), “10” (medium droplet), and “01” (small droplet) to both of the third head 23 and the second head 22, in addition to and separately from the above-described driving waveform. The data received by each of the third head 23 and the second head 22 is collated by the multiplexer included in each of the third head 23 and the second head 22.

In a case where the third head 23 and the second head 22 move at the first speed, the driving waveform Wd1 (driving waveform in which the volume of the small droplet is not divided into the plurality of extra-small droplets) for ejecting the small droplet is transmitted to each of the third head 23 and the second head 22 by the second controller 50. On the other hand, in a case where the third head 23 and the second head 22 move at the second speed, the driving waveform Wd2 for dividing the volume of the small droplet into the plurality of extra-small droplets and ejecting the plurality of extra-small droplets is transmitted to each of the third head 23 and the second head 22 by the second controller 50, rather than transmitting the driving waveform Wd1. In this case, in a case where the third head 23 and the second head 22 are moved at the first speed, the ink droplet is ejected only from the third head 23 and the ink droplet is not ejected from the second head 22, and thus an extra-small droplet is not ejected from the second head 22. On the other hand, in a case where the third head 23 and the second head 22 move at the second speed, the ink droplets are ejected only from the second head 22, and the ink droplets are not ejected from the third head 23, and thus the extra-small droplets are not ejected from the third head 23. As a result, even with the same “01” signal, the small droplet ejected from the third head 23 is not divided into the extra-small droplets, and only the small droplet which is to be ejected from the second head 22 is divided with into the extra-small droplets.

Alternatively, the following aspect may be adopted. In the second printing process, the second controller 50 transmits the driving waveform Wd2 for dividing the volume of the small droplet into the plurality of extra-small droplets and ejecting the plurality of extra-small droplets, rather than transmitting the driving waveform Wd1 for ejecting the small droplet which can be ejected from the second head 22. In this case, the second controller 50 transmits the driving waveform Wd1 to the third head 23 and transmits the driving waveform Wd2 to the second head 22. Further, the second controller 50 transmits the data indicated by each of the signals of the ink droplet size of “11” (large droplet), “10” (medium droplet), and “01” (small droplet) to both of the third head 23 and the second head 22, in addition to and separately from the driving waveform. The data received by each of the third head 23 and the second head 22 is collated by the multiplexer included in each of the third head 23 and the second head 22.

The second controller 50 transmits, to the third head 23, the driving waveform Wd1 for ejecting the small droplet (the driving waveform with which the volume of the small droplet is not divided into the plurality of extra-small droplets). On the other hand, the second controller 50 transmits, to the second head 22, the driving waveform Wd2 for dividing the volume of the small droplet with into the plurality of extra-small droplets and ejecting the plurality of extra-small droplets, instead of transmitting, to the second head 22, the driving waveform Wd1 for ejecting the small droplet. Also in this aspect, as a result, even with the same “01” signal, the small droplet ejected from the third head 23 is not divided into the extra-small droplets, and only the small droplet which is to be ejected from the second head 22 is divided into the extra-small droplets.

Alternatively, the following aspect may be adopted. The second controller 50 supplies a driving voltage which is higher than the driving voltage of the third head 23 to the second head 22 via the second head-driving circuit 54. Further, the second controller 50 then uses, in the second head 22, a driving waveform which indicates the driving voltage higher than the driving voltage of the driving waveform for ejecting the small droplet as the ink droplet of the color ink in the third head 23, so as to divide the volume of the small droplet into a plurality of extra-small droplets and to cause the second head 22 to eject the plurality of extra-small droplets as the ink droplets of the clear ink from the nozzle 221. Thus, in the present aspect, the driving waveform used in the third head 23 and the driving waveform used in the second head 22 have similar shapes (shapes which are not completely identical). That is, while the driving waveform used in the third head 23 and the driving waveform transmitted to the second head 22 have the same pulse width and the same timing with respect to each of the High pulse and the Low pulse, the voltage (driving voltage) of the High pulse in the driving waveform used in the second head 22 is higher than the voltage (driving voltage) of the High pulse in the driving waveform used in the third head 23. In other words, the second controller 50 supplies the driving waveform Wd2 to the second head 22 so that the volume of the small droplet is divided with the plurality of extra-small droplets and the second head 22 is caused to eject the plurality of extra-small droplets from the nozzle 221. The driving waveform Wd2 indicates that the voltage (driving voltage) of the High pulse in the driving waveform used in the second head 22 is higher than the voltage (driving voltage) of the High pulse in the driving waveform used in the third head 23.

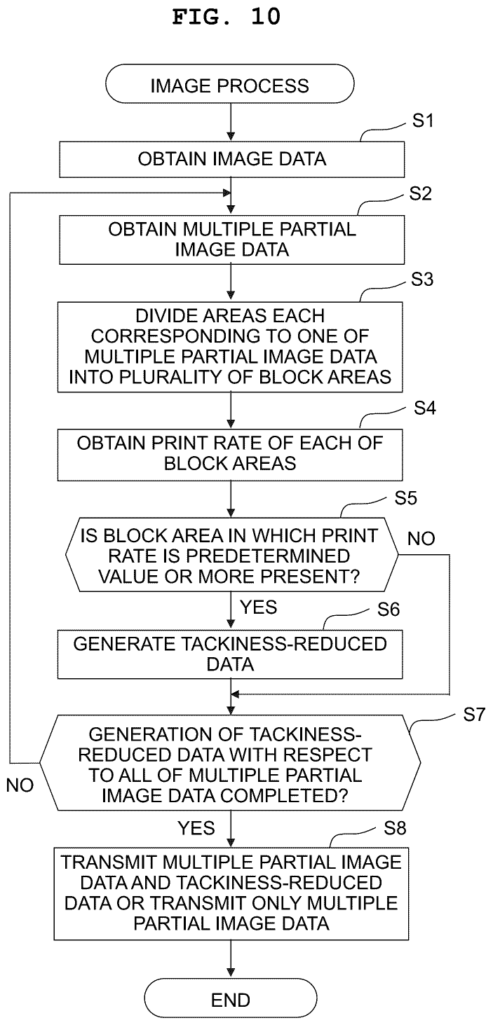

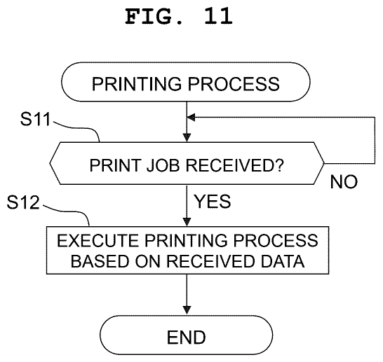

Next, the flow of a series of processes in the printing apparatus 100 of the present embodiment will be described using flowcharts. FIG. 10 is a flowchart indicating the flow of a process in the image processing device 102. FIG. 11 is a flowchart depicting the flow of a process in the output device 101.

As depicted in FIG. 10, the first controller 61 of the image processing device 102 first obtains the image data (step S1). Next, the first controller 61 executes the process of obtaining the multiple partial image data PD each of which partially constructs the image data (step S2).

Next, the first controller 61 divides the areas each of which corresponds to one of the multiple partial image data PD into the plurality of block areas BR (step S3). Then, the first controller 61 obtains the print rate in each of the divided block areas BR (step S4). After that, the first controller 61 determines whether the printing rate in each of the block areas BR is the predetermined value (e.g., 50%) or more, regarding each of the block areas BR (step S5). In a case where the printing rate in a certain block area BR included in the block areas BR in certain partial image data PD among the multiple partial image data PD is the predetermined value or more (YES in step S5), the first controller 61 generates the second print data (tackiness-reduced data) with respect to the certain partial image data PD including the certain block area BR in which the printing rate is the predetermined value or more (step S6).

In a case where the first controller 61 determines that the printing rate in each of the block areas BR is not the predetermined value or more (NO in step S5), and after the process of step S6, the first controller 61 determines whether the second print data (tackiness-reduced data) has been generated with respect to all of the multiple partial image data PD (step S7). In a case where the first controller 61 determines that the second print data has been generated with respect to all of the multiple partial image data PD (YES in step S7), the first controller 61 transmits the multiple partial image data PD and the second print data, or only the multiple partial image data PD, to the second controller 50 of the output device 101 (step S8). On the other hand, in a case where the first controller 61 determines that the second print data has not been generated with respect to all of the multiple partial image data PD (NO in step S7), the first controller 61 returns to the process of step S2 and repeats the process of step S2 and the processes subsequent to the process of step S2.

As depicted in FIG. 11, the second controller 50 of the output device 101 determines whether the print job has been received from the first controller 61 of the image processing device 102 (step S11). In a case where the second controller 50 determines that the data related to the print job has been received (YES in step S11), the second controller 50 executes the printing process based on the received data (step S12). On the other hand, in a case where the second controller 50 determines that the data related to the print job has not been received (NO in step S11), the second controller 50 stands by until the print job is transmitted from the first controller 61.

As described above, according to the printing apparatus 100, in the second printing process, the nozzles 221 ejects the droplets of the clear ink, having the amount smaller than the amount of the droplets of the color ink, onto the droplet of the color ink which have landed on the print medium W. Further, the total area of the droplets of the clear ink landed on the droplets of the color ink is smaller than the total area of the image formed of the droplets of the color ink landed on the print medium W. With this, the ejected droplets of the clear ink can be easily cured by the ultraviolet ray before the ejected droplets of the clear ink wet and spread on the liquid droplets of the color ink. Accordingly, the contact area in the print surface, of the print medium W, in a case where a person touches the contact area can be made small. Thus, the stickiness of the print surface of the print medium can be reduced.

Further, in the present embodiment, the first controller 61 generates the first print data for ejecting the ink droplets of the color ink from the nozzle 321 onto the print medium W, based on the image data. Furthermore, the first controller 61 generates the second print data for ejecting the ink droplets of the clear ink from the nozzle 221 onto the ink droplets of the color ink which have landed on the print medium, based on the image data. Since the first print data and the second print data are based on the same image data in such a manner, a position, other than the position at which the ink droplet of the color ink is be ejected and at which the ink droplet of the clear ink is not to be ejected, can be easily recognized. With this, the ink droplet of the clear ink is not ejected more than intended, and thus the clear ink can be saved.

Moreover, in the present embodiment, in a case where the second controller 50 causes the second head 22 to eject the ink droplets of the clear ink from the nozzles 221 in the second printing process, the second controller 50 causes the carriage 41 to move in the moving direction Ds at the second speed faster than the first speed. This allows the ink droplets of the clear ink to be cured by the ultraviolet ray before the ink droplets of the clear ink wet and spread on the ink droplets of the color ink.

Further, in the present embodiment, the second controller 50 uses, as the ink droplet of the clear ink in the second printing process, the small droplet among the large droplet, medium droplet, and small droplet which can be ejected from the nozzle 221. In this case, the ink droplet of the clear ink, which is a small droplet, is ejected onto the ink droplet of the color ink, which is a large droplet and which has landed on the print medium W. With this, the ejection amount of the ink droplet of the clear ink can be easily made smaller than the ejection amount of the ink droplet of the color ink. Furthermore, before the ink droplet of the clear ink wets and spreads on the ink droplet of the color ink, the ink droplet of the clear ink is easily cured by the ultraviolet ray. Accordingly, the contact area in the print surface of the print medium W in a case where a person touches the contact area can be made small.

Further, in the present embodiment, in the second printing process, the second controller 50 performs the switching from the driving waveform Wd1 in FIG. 9A for causing the second head 22 to eject the small droplet, which can be ejected from the nozzle 221, to the driving waveform Wd2 in FIG. 9B for dividing the volume of the small droplet into the plurality of extra-small droplets and causing the second head 22 to eject the plurality of extra-small droplets from the nozzle 221. With this, the ink droplet of the clear ink which is the extra-small droplet is ejected onto the ink droplet of the color ink, and the amount of the ink droplet of the clear ink can be made smaller than the amount of the ink droplet of the color ink.

Furthermore, in the present embodiment, in the second printing process, the second controller 50 may use the driving waveform Wd2 for dividing the volume of the small droplet into the plurality of extra-small droplets and ejecting the plurality of extra-small droplets, rather than using the driving waveform Wd1 for ejecting the small droplet which can be ejected from the second head 22. In this case, the driving waveform Wd1 is transmitted to the third head 23, and the driving waveform Wd2 is transmitted to the second head 22. Also in this case, the ink droplet of the clear ink which is the extra-small droplet is ejected onto the ink droplet of the color ink, and the amount of the ink droplet of the clear ink can be made smaller than the amount of the ink droplet of the color ink.

Moreover, in the present embodiment, the second controller 50 uses, in the second head 22, the driving waveform which indicates the driving voltage higher than the driving voltage of the driving waveform for ejecting the small droplet as the ink droplet of the color ink in the third head 23, so as to divide the volume of the small droplet into the plurality of extra-small droplets and to cause the second head 22 to eject the plurality of extra-small droplets as the ink droplet of the clear ink from the nozzle 221. Also with this, the ink droplet of the clear ink, which is the extra-small droplet, can be ejected on the ink droplet of the color ink.

Further, in the present embodiment, in the second printing process, the second controller 50 causes the second head 22 to eject the ink droplets of the clear ink from the nozzles 221 in the printing pass in which the print range by the second head 22 becomes maximum. With this, the ink droplets of the clear ink can be ejected in one pass with respect to the area to which the ink droplets of the clear ink are to be ejected, thereby leading to improved process efficiency.

Furthermore, in the present embodiment, the second controller 50 executes the second printing process so that the first area Rr1 to which the ink droplets of the clear ink are ejected by the nozzles 221 in the first printing pass and the second area Rr2 to which the ink droplets of the clear ink are ejected in the second printing pass subsequent to the first printing pass do not overlap. In this case, unnecessary consumption of the clear ink, which would be otherwise caused due to the ink droplet of the clear ink being ejected onto and overlapped in the first area Rr1 and the second area Rr2, can be avoided.

Moreover, in the present embodiment, the first printing process, the second printing process, and the curing process are performed for each of the multiple partial image data PD. In this case, since the first printing process, the second printing process, and the curing process are performed with respect to each of the multiple partial image data PD, the time since the first printing process and the second printing process and until the start of the curing process can be shortened, as compared with such a case where each of the first printing process, the second printing process, and the curing process is performed with respect to the entirety of the image data. With this, the ink droplets of the clear ink can be easily and quickly cured by the ultraviolet ray before the ink droplets of the clear ink wet and spread on the ink droplets of the color ink.

Further, in the present embodiment, the first controller 61 determines whether the printing rate in each of the block areas BR is the predetermined value or more with respect to each of the block areas BR; and in the case where the printing rate is the predetermined value or more in a certain block area BR included in the block areas BR in certain partial image data PD among the multiple partial image data PD, the first controller 61 generates the second print data with respect to the certain partial image data PD including the certain block area BR in which the printing rate is the predetermined value or more. In this case, the generation of the second print data with respect to an area in which the stickiness does not occur on the print surface of the print medium Wis avoided.

Furthermore, in the present embodiment, the first controller 61 generates the second print data with respect to each of the block areas BR in which the printing rate is the predetermined value or more. In this case, the load of the process of the first controller 61 can be reduced.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below:

In the above-described embodiment, the light sources 80 may be disposed both upstream and downstream in the moving direction Ds of each of the heads 20. In this case, the first printing process, the second printing process, and the curing process can be performed in the forward path and the return path of the moving direction Ds.

Further, in the above-described embodiment, the second head 22 and the third head 23 may be supported, separately, on different carriages.

Furthermore, in the above-described embodiment, although each of the heads 20 is of the serial head system, the present disclosure is not limited to this. Each of the heads 20 may be of the line head system.

Moreover, in the above-described embodiment, the image processing device 102 and the output device 101 are configured separately and independently, and the concept which encompasses the image processing device 102 and the output device 101 is defined as the printing apparatus (or printing system) 100. The present disclosure, however, is not limited to this. A processing part capable of executing the same process as the process executed by the image processing device 102 and a processing part capable of executing the same process as the process executed by the output device 101 may be disposed in one printing apparatus.

What is claimed is:

1. A printing apparatus comprising:
a head system including:
a first nozzle configured to eject a first liquid droplet onto a print medium based on image data, the first liquid droplet being ultraviolet ray-curable; and
a second nozzle configured to eject a second liquid droplet, the second liquid droplet being ultraviolet ray-curable, being different from the first liquid droplet and having an amount smaller than an amount of the first liquid droplet;
a light source configured to irradiate an ultraviolet ray for curing the first liquid droplet and the second liquid droplet; and
a controller, wherein
the controller is configured to execute:
causing the head system to eject the first liquid droplet from the first nozzle based on the image data;
after causing the head system to eject the first liquid droplet from the first nozzle based on the image data, causing the head system to eject the second liquid droplet from the second nozzle onto the first liquid droplet landed on the print medium; and
causing the light source to irradiate the first liquid droplet and the second liquid droplet on the print medium with the ultraviolet ray, and
a total area of the second liquid droplet landed on the first liquid droplet is smaller than a total area of an image composed of the first liquid droplet landed on the print medium.

2. The printing apparatus according to claim 1, wherein
the controller is configured to further execute:
generating, based on the image data, first print data for causing the head system to eject the first liquid droplet from the first nozzle onto the print medium; and
generating, based on the image data, second print data for causing the head system to eject the second liquid droplet from the second nozzle onto the first liquid droplet landed on the print medium.

3. The printing apparatus according to claim 1, wherein
the head system includes:
a first head having the first nozzle; and
a second head having the second nozzle,
the printing apparatus further comprises a carriage configured to move in a moving direction while supporting the first head and the second head,
the controller is configured to cause the carriage to move in the moving direction at a first speed in a case where the controller causes the first head to eject the first liquid droplet from the first nozzle, and to cause the carriage to move in the moving direction at a second speed faster than the first speed in a case where the controller causes the second head to eject the second liquid droplet from the second nozzle.

4. The printing apparatus according to claim 1, wherein
the second nozzle is configured to eject a large droplet and a small droplet, and
the controller is configured to use the small droplet as the second liquid droplet to be ejected from the second nozzle, rather than the large droplet.

5. The printing apparatus according to claim 1, wherein
the second nozzle is configured to eject a small droplet, and
the controller is configured to perform switching from a driving waveform for causing the head system to eject the small droplet from the second nozzle to a driving waveform for dividing a volume of the small droplet into a plurality of extra-small droplets and causing the head system to eject the plurality of extra-small droplets from the second nozzle.

6. The printing apparatus according to claim 1, wherein
the head system includes:
a first head having the first nozzle; and
a second head having the second nozzle,
the controller causes the first head to eject the first liquid droplet from the first nozzle,
the controller causes the second head to eject the second liquid droplet from the second nozzle onto the first liquid droplet landed on the print medium, and
the second nozzle is configured to eject a small droplet, and the controller transmits a driving waveform for dividing a volume of the small droplet into a plurality of extra-small droplets and causing the second head to eject the plurality of extra-small droplets from the second nozzle, rather than transmitting a driving waveform for causing the second head to eject the small droplet from the second nozzle.

7. The printing apparatus according to claim 1, wherein
the head system includes:
a first head having the first nozzle; and
a second head having the second nozzle,
the second head has a driving voltage higher than a driving voltage of the first head, and
the controller transmits a driving waveform to the second head, the driving waveform indicating a driving voltage higher than a driving voltage of another driving waveform for causing the first head to eject a small droplet as the first liquid droplet from the first nozzle, so that a volume of the small droplet is divided with a plurality of extra-small droplets and that the second head is caused to eject the plurality of extra-small droplets from the second nozzle.

8. The printing apparatus according to claim 3, wherein
the second head is disposed downstream of the first head in a conveying direction of the print medium, and
the controller causes the second head to eject the second liquid droplet in a pass from the second nozzle, a print range by the second head becoming maximum in the pass.

9. The printing apparatus according to claim 8, wherein
the controller executes: causing the second head to eject the second liquid droplet from the second nozzle onto the first liquid droplet landed on the print medium so that a first area and a second area do not overlap, the second liquid droplet being ejected to the first area from the second nozzle in a first pass and the second liquid droplet being ejected to the second area from the second nozzle in a second pass subsequent to the first pass.

10. The printing apparatus according to claim 2, wherein
the controller is configured to execute: obtaining multiple partial image data each partially constructing the image data, and
the controller causes the head system to eject the first liquid droplet from the first nozzle, causes the head system to eject the second liquid droplet from the second nozzle onto the first liquid droplet landed on the recording medium, and causes the light source to irradiate, with the ultraviolet ray, the first liquid droplet and the second liquid droplet on the print medium, with respect to each of the multiple partial image data.

11. The printing apparatus according to claim 10, wherein
the controller is configured to execute:
dividing an area corresponding to each of the multiple partial image data into a plurality of block areas; and
determining whether a printing rate in each of the plurality of block areas is a predetermined value or more, and
in a case where the controller determines that the printing rate in a block area, of the plurality of block areas is the predetermined value or more, the controller is configured to execute: generating the second print data with respect to partial image data, of the multiple partial image data, including the block area having the printing rate of the predetermined value or more.

12. The printing apparatus according to claim 11, wherein
the controller is configured to generate the second print data with respect to a block area or each of block areas, of the plurality of block areas, having the printing rate of the predetermined value or more.

13. A printing method using a printing apparatus including:
a head system including:
a first nozzle configured to eject a first liquid droplet onto a print medium based on image data, the first liquid droplet being ultraviolet ray-curable;
a second nozzle configured to eject a second liquid droplet, the second liquid droplet being ultraviolet ray-curable, being different from the first liquid droplet and having an amount smaller than an amount of the first liquid droplet; and
a light source configured to irradiate an ultraviolet ray for curing the first liquid droplet and the second liquid droplet,
the printing method comprising:
causing the head system to eject the first liquid droplet from the first nozzle based on the image data;
after causing the head system to eject the first liquid droplet from the first nozzle, causing the head system to eject the second liquid droplet from the second nozzle onto the first liquid droplet landed on the print medium; and
causing the light source to irradiate the first liquid droplet and the second liquid droplet on the print medium with the ultraviolet ray, wherein
a total area of the second liquid droplet landed on the first liquid droplet is smaller than a total area of an image formed of the first liquid droplet landed on the print medium.

14. A non-transitory and computer-readable medium storing a printing program executable by a computer in a printing apparatus, the printing apparatus including:
a head system including:
a first nozzle configured to eject a first liquid droplet onto a print medium based on image data, the first liquid droplet being ultraviolet ray-curable;
a second nozzle configured to eject a second liquid droplet, the second liquid droplet being ultraviolet ray-curable, being different from the first liquid droplet and having an amount smaller than an amount of the first liquid droplet; and
a light source configured to irradiate an ultraviolet ray for curing the first liquid droplet and the second liquid droplet,
the printing program causing the computer to execute:
causing the head system to eject the first liquid droplet from the first nozzle based on the image data;
after causing the head system to eject the first liquid droplet from the first nozzle, causing the head system to eject the second liquid droplet from the second nozzle onto the first liquid droplet landed on the print medium; and
causing the light source to irradiate the first liquid droplet and the second liquid droplet on the print medium with the ultraviolet ray, wherein
a total area of the second liquid droplet landed on the first liquid droplet is smaller than a total area of an image formed of the first liquid droplet landed on the print medium.
